(19) United States
(12) Patent Application Publication
(10) Pub. No.: US 2025/0299440 A1
(43) Pub. Date: Sep. 25, 2025

(54) METHOD FOR RAPIDLY GENERATING MULTIPLE CUSTOMIZED USER AVATARS

(71) Applicant: GAMANIA DIGITAL ENTERTAINMENT CO., LTD., Taipei City (TW)

(72) Inventors: You-Xiang Chen, Taipei City (TW); Yu-Lin Chien, Taipei City (TW); Tsung-Wei Weng, Taipei City (TW); Wei-Lun Su, Taipei City (TW); Yu-Yin Lee, Taipei City (TW); Chuin-Yien Lim, Taipei City (TW); Hsin-Yu Chiang, Taipei City (TW)

(21) Appl. No.: 18/677,419

(22) Filed: May 29, 2024

(30) Foreign Application Priority Data
Mar. 20, 2024 (TW) 113110289

(51) Int. Cl. G06T 17/00; G06V 10/764

(52) U.S. Cl. CPC G06T 17/00; G06V 10/764

(57) ABSTRACT

Method for rapidly generating multiple customized user avatars including a user selects a plurality of classifying labels according to his own preferences, including person/action/background/object/ornament label. The computation processor combines those classifying labels into a label parameter groups, and filters out the same or similar ones from the model parameter list according to the label parameter group a plurality of model parameters corresponding to those label parameter groups. Further, the computation processor extracts a corresponding plurality of avatar models from the model database according to those model parameters, and then packages those avatar models and sends them to the application program. The application program receives those avatar models and unpacks them and displays them for the user to select, if the user selects one of those avatar models, the application program binds the avatar models to the user.

### CROSS-REFERENCE TO RELATED APPLICATIONS

This non-provisional application claims priority under 35 U.S.C. § 119 on Patent Application No. TW113110289 filed in Taiwan, Republic of China Mar. 20, 2024, the entire contents of which are hereby incorporated by reference in its entirety.

### FIELD OF THE INVENTION

The present invention relates to a method for generating avatar images, and more particularly to a method to quickly generate multiple user avatars.

### BACKGROUND OF INVENTION

Most of the current social software applications allow users to change their user avatars. However, at present, the methods for changing avatars are limited, and users have few choices. They may select images from a default image bank or upload their own images to be used as their avatars. Such methods do not provide much customization and personal identification, and therefore cannot meet the need of users for good experience.

Some software applications have the ability to generate user avatars through graphics software based on user photos, similar to the function of a beauty camera. However, such a real-time image generating method requires 5 to 10 minutes for image production. It requires participation of the user for editing, which may take a long time. Moreover, it is unable to satisfy some special user needs.

### SUMMARY OF THE INVENTION

In view of this, the present invention provides Method for rapidly generating multiple customized user avatars. It effectively solves the shortcoming of the prior art wherein the user avatars lack customization and personal identification. Based on user preference, it can quickly generate multiple groups of user avatars for the user to select, saving considerable production time while increasing the proprietary features of the avatars.

Method for rapidly generating multiple customized user avatars, the administrator selects a plurality of classifying labels including person label, action/background label, object/ornament label, the computation processor obtains the corresponding label from a label database according to those classifying labels a plurality of label parameter, combine those label parameters into a plurality of label parameter groups according to a label grouping method and store them into a label parameter group list, the computation processor extracts those classifying labels involved in the label parameter group list from a multimedia The database extracts the corresponding an image file list, and arranges a plurality of model parameters according to the label parameter group list and the image file list and stores it as a model parameter list, an avatar training processor extracts the model parameter list from the model database, According to each group of those model parameters, a corresponding plurality of image files is extracted from the multimedia database, a deep-learning text-to-image diffusion model (Stable Diffusion) is used to generate a plurality of avatar models, and those avatar models correspond to the model parameters and stored in the model database.

A user executes an application program on an electronic device to open a classifying label selection interface. The user selects a plurality of classifying labels according to his own preferences, including person label, action/background label, object/ornament label, and the application program send those classifying labels to a computation processor, the computation processor combines those classifying labels into a label parameter groups, extracts a model parameter list from a model database, and filters out the same or similar ones from the model parameter list according to the label parameter group a plurality of model parameters corresponding to those label parameter groups. Further, the computation processor extracts a corresponding plurality of avatar models from the model database according to those model parameters, and then packages those avatar models and sends them to the application program. The application program receives those avatar models and unpacks them and displays them for the user to select, if the user selects one of those avatar models, the application program binds the avatar models to the user.

If the user is not satisfied, he can click a re-generation icon, and the application program notifies the computation processor to extract the plurality of image corresponding to those model parameters corresponding to the label parameter groups from the multimedia database according to each group. The files are sent to the avatar training processor, and then the deep-learning text-to-image diffusion model (Stable Diffusion) is used to instantly generate those avatar models. Those avatar models are then packaged and sent to the application program for the user to select.

The classifying label can designate three presentation methods to present user preference. With three presentation methods, the images produced by AI will more likely meet the anticipation of users.

The deep-learning text-to-image diffusion model (Stable Diffusion) is preset to generate avatar models in a non-portrait style, for example, through personification and cartoonization to avoid over-realistic presentation.

Based on the texts selected or entered in the classifying label selection interface according to user preference, ChatGPT can generate strongly correlated action descriptions. In order to diversify the images generated from the classifying label, multiple action descriptions are generated from one classifying label to help generating the images. For instance, if the action classifying label is dessert, the generated images will include eating a pie, making biscuits, enjoying a chocolate cake etc.

A strongly correlated background image will be generated based on user preference and the generated action descriptions. For instance, if the action classifying label is making biscuits, the generated background image will include dining hall, kitchen etc.

Strongly correlated objects will be generated based on user preference and the generated action descriptions.

Each avatar model image is generated based on multiple user preferences and the selection of the user. Apart from generating images best meeting the three preferences, the system will record the generated labels in the database. When the user selects three classifying labels to be generated in the application program, the system will search out the most similar avatar models from the database and display them on the selection page.

When the user registers the avatar model, the application program will record the user's selection and non-selection, and add them to the user behavior.

### BRIEF DESCRIPTION OF THE DRAWINGS

FIG. 1 The block diagram of a system to quickly generate multiple groups of customized user avatars.

FIG. 2 The block diagram of an Image files generation method corresponding to a plurality of classifying labels.

FIG. 3 The flow chart of an avatar models training method.

FIG. 4 The flow chart of generate a user avatar method.

FIG. 5 Embodiment of the generate a user avatar based on selected those classifying labels.

FIG. 6 Another embodiment of the generate a user avatar based on selected those classifying labels.

FIG. 7 Embodiment of the generate a user avatar based on input those classifying labels.

FIG. 8 Embodiment of the generate a user avatar based on input text string in those classifying labels.

### DETAILED DESCRIPTION OF THE INVENTION

### Embodiment 1

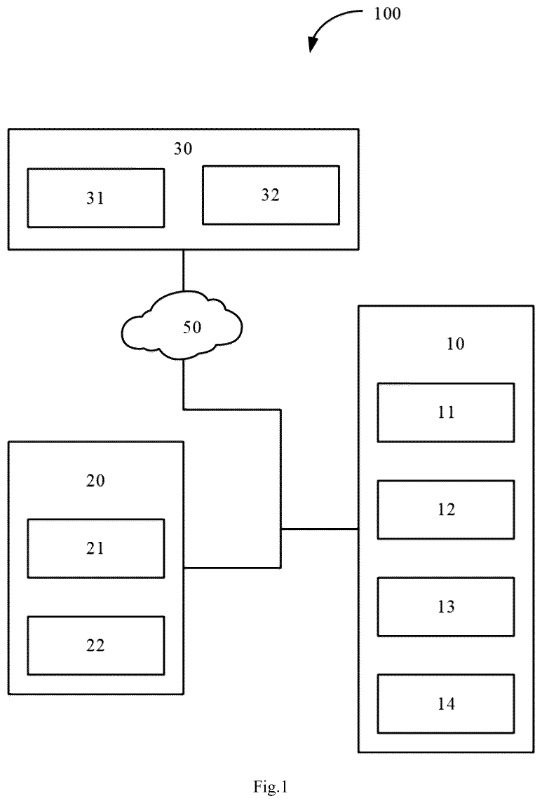

A system 100 using Method for rapidly generating multiple customized user avatars is shown in FIG. 1. The system 100 includes: a database server 10, the database server 10 including: a label database 11, including a plurality of classifying labels, a classifying label list 60, those classifying labels respectively corresponding to a label parameter, those classifying labels including a garment label, an action label, an object label, and another label; a multimedia database 12, including a plurality of image files, corresponding a plurality of file codes, and an image file list, those image files related to those classifying labels; a model database 13, including a plurality of avatar models, corresponding a plurality of model parameters, a label parameter group list, and a model parameter list; a user database 14, including a user data and a user behavior; a model training server 20, electronically connected to the database server 10, the model training server 20 including: a computation processor 21, to organize those label parameters corresponding to the classifying labels into a plurality of label parameter groups based on a label grouping method, and save the label parameter group list in the model database 13; an avatar training processor 22, to extract related those image files from the multimedia database 12 based on the label parameters in corresponding those label parameter groups, use a deep-learning text-to-image diffusion model 70 (Stable Diffusion) to generate those avatar models, and save those avatar models in the model database 13 according to those model parameters, those model parameters being corresponding to those label parameter groups; an electronic device 30, to access the model training server 20 through an Internet 50, the electronic device 30 including: an application program 31, providing a classifying label selection interface, whereby a user can select those classifying labels for generating a user avatar; and a displaying screen 32, to display those avatar models for the user to select and/or register the user avatar.

Stable Diffusion is a deep-learning text-to-image diffusion model, which is mainly used to generate detailed images from text descriptions, and to generate images from images under guidance of text prompts. Stable Diffusion is a variant of diffusion model known as “latent diffusion model (LDM)”.

The number of those avatar models generated by each group of the model parameters through the deep-learning text-to-image diffusion model 70 (Stable Diffusion) can be set by an administrator.

The application program 31 also includes a registration interface. Through the registration interface, the user can register selected the avatar model as the user avatar, and the registration interface will transmit a signal to the model database 13 of the database server 10 to lock the avatar model and mark corresponding a status code as registered.

The computation processor 21 further includes statistics of the user behaviors based on those classifying labels selected by the user and/or the model parameters corresponding to the user avatar registered by the user.

In an embodiment, the status code includes 0: unavailable, 1: available, and 2: registered.

The application program 31 also includes an editing interface, through which the user can edit the user avatar.

The application program 31 further includes a re-generation icon. In case the user is not satisfied with the current batch of those avatar models, he/she can click the re-generation icon for the avatar training processor 22 to generate those avatar models in real time according to those classifying labels selected by the user.

Preferably, the label grouping method puts 3 classifying labels in one group, including the garment label, the action label, and the object label.

In an embodiment, those classifying labels further includes a plurality of primary labels and a plurality of secondary labels. Those primary labels include but are not limited to the garment label, the action label, the object label, and another primary label. Those secondary labels include but are not limited to a person label, a background label, an ornament label, a style label and another secondary label.

In an embodiment, the secondary label is bound to the primary label. For instance, the background label is bound to the action label, and the ornament label is bound to the object label. If the action label is playing basketball, the bound background label is basketball court. If the object label is vehicle, the bound ornament label is a safety helmet.

In an embodiment, the label grouping method further includes randomly selecting labels from those primary labels and those secondary labels as model training conditions.

In an embodiment, the action label is combined with the background label, and the object label is combined with the ornament label. Through the classifying label selection interface, the user can select from the garment label, the action/background label, and the object/ornament label.

In an embodiment, the classifying label selection interface randomly displays those primary labels and/or those secondary labels for the user to select.

In an embodiment, the label grouping method further includes setting of those primary labels and/or those secondary labels as the model training condition by the administrator, or setting of the classifying label selection interface by the administrator to display those primary labels and/or those secondary labels for the user to select.

In an embodiment, those classifying labels corresponding to those model parameters with a rate of successful avatar generation above a threshold value are set as the training condition for the avatar training processor 22 and/or the classifying labels to be displayed on the classifying label selection interface. The method to calculate the rate of successful avatar generation includes the rate of successfully meeting the user's requirement on the first generation.

In an embodiment, the classifying labels displayed on the classifying label selection interface are an accumulation of all the classifying labels selected by the users on the application program 31. They are displayed in sequence based on the combination of statistical numbers and proportions of each category. Or, the top three with highest numbers are displayed.

The garment label includes but is not limited to basketball jerseys, swimsuits, hip-hop clothing etc.

The action label includes but is not limited to basketball shooting, swimming, dancing etc.

The object label includes but is not limited to basketball, swimming glasses, jazz drum etc.

The background label includes but is not limited to basketball court, seaside, snowscape, etc.

The ornament label includes but is not limited lapel pin, headgear, swimming ring, tattoo etc.

The person label includes but is not limited to humans, cartoon characters, virtual characters, animals etc.

The style label includes but is not limited to Japanese style, American style, Disney style, personification, cartoonization, etc.

In an embodiment, the classifying label selection interface also includes a classifying label input field. Those classifying labels are entered into the classifying label input field by the user, and are classified into a close classifying label after analysis by a natural language.

Those image files and those image file codes are all connected to corresponding those classifying labels. For instance, if the classifying label is garment label (A) and those image files are basketball jerseys (a), those image file codes will be basketball jersey image file 1 (the image file is coded Aa001), basketball jersey image file 2 (the image file is coded Aa002), and basketball jersey image file 3 (the image file is coded Aa003).

According to sizes, those avatar models include large images (for example, having a resolution ratio of 512*512) and thumbnails (for example, having a resolution ratio of 128*128).

The user data includes name, account number, password, interest, gender, age, blood type, etc.

The user behavior further includes interaction data of the user collected by the APP from buried points on platforms related to the server of the application program 31, including clicked contents, participated contests, joined groups etc. For example, a statistical record of the user's past interaction data {‘basketball’: {‘cnt’: 100, ‘pref’: 0.8}} indicates the user has totally interacted with 100 contents related to the category of basketball, accounting for 80% of the user's preference.

The model training server 20 further includes a similarity computing to compute a degree of model similarity between those avatar models in the same group.

A system 100 using Method for rapidly generating multiple customized user avatars further includes an administrator interface, whereby the administrator can set an avatar model similarity percentage. In the form of groups, those avatar models with their similarity percentage higher than or equal to the set value can be extracted from the model database 13, and the administrator can choose to maintain or delete any avatar model.

The administrator interface also includes an avatar model optimization record, whereby the administrator can screen the avatar models saved in the model database 13. The administrator interface will save the screening record as the avatar model optimization record and transmit it to the avatar training processor 22 for learning and training.

The electronic device 30 includes a computer, a tablet, a smart watch, such as a PC, a mobile client end or the like.

### Embodiment 2

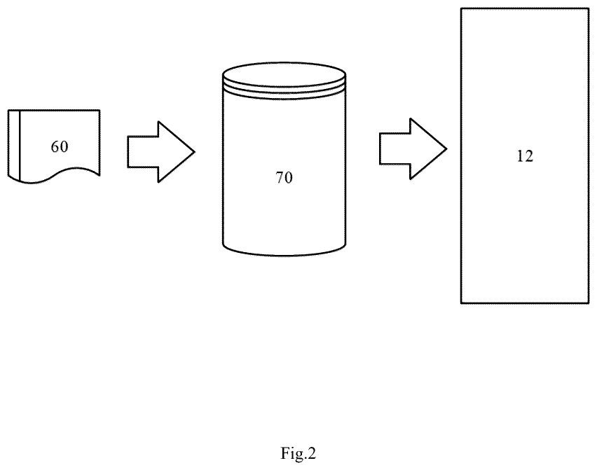

Method for rapidly generating multiple customized user avatars is shown in FIG. 2. The method to generate an image file corresponding to a classifying label includes extracting a classifying label list 60 by an avatar training processor 22 of a model training server 20 from a label database 11 of a database server 10. Based on a plurality of classifying label text contents, a deep-learning text-to-image diffusion model 70 is used to generate a plurality of image files. Those image files are related to those classifying labels and saved to a multimedia database 12.

### Embodiment 3

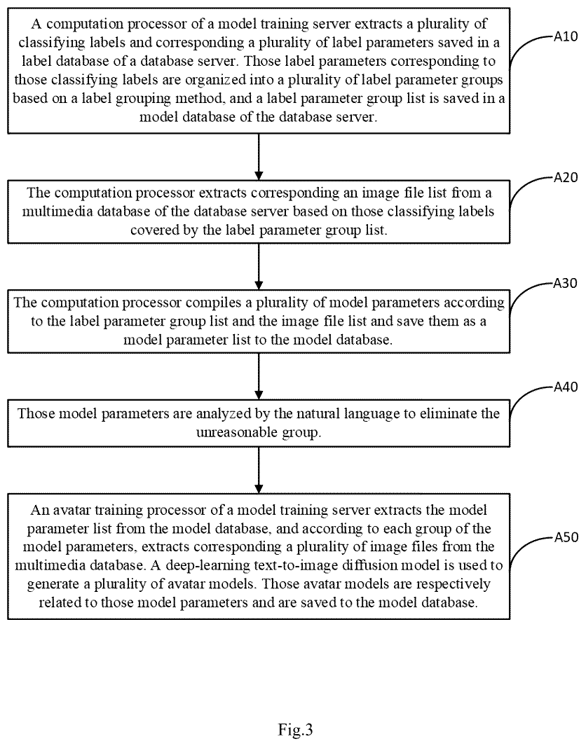

Method for rapidly generating multiple customized user avatars, wherein, as shown in FIG. 3, the avatar model training method includes: Step A10. A computation processor 21 of a model training server 20 extracts a plurality of classifying labels and corresponding a plurality of label parameters saved in a label database 11 of a database server 10. Those label parameters corresponding to those classifying labels are organized into a plurality of label parameter groups based on a label grouping method, and a label parameter group list is saved in a model database 13 of the database server 10. Below is a description of an example using 4 labels to form a group of 3, but the example is not intended to limit scope of the present invention.

| | Classifying | | | Label |
|---|---|---|---|---|
| | labels | | | parameter |
| Group | (Label parameter) | | | groups |
| 1 | garment | action label(B) | object label(C) | ABC |
| | label(A) | | | |
| 2 | garment | action label(B) | person label(D) | ABD |
| | label(A) | | | |
| 3 | garment | person label(C) | object label(D) | ACD |
| | label(A) | | | |
| 4 | person | action label(C) | object label(D) | BCD |
| | label(B) | | | |

Step A20. The computation processor 21 extracts corresponding an image file list from a multimedia database 12 of the database server 10 based on those classifying labels covered by the label parameter group list. An example is described below, but not intended to limit the scope of the present invention.

| | |
|---|---|
| | Image file |
| | list-Image files |
| Label | (file codes) |

| | | | |
|---|---|---|---|
| garment | basketball jerseys | basketball jerseys | swimsuits |
| label(A) | (a001) | (a002) | (b001) |
| action | basketball shooting | swimming | dancing |
| label(B) | (e001) | (f001) | (g001) |
| object | basketball | swimming glasses | bat |
| label(C) | (i001) | (j001) | (k001) |
| person | cartoon | personification | cat |
| label(D) | characters | virtual | (o001) |
| | (m001) | (n001) | |

Step A30. The computation processor 21 compiles a plurality of model parameters according to the label parameter group list and the image file list and save them as a model parameter list to the model database 13. An example is described below, but not intended to limit the scope of the present invention.

Model parameter list

| ABC | ABD | ACD | BCD |
|---|---|---|---|
| a001-e001-i001 | a001-e001-m001 | a001-i001-m001 | e001-i001-m001 |
| a001-e001-j001 | a001-e001-n001 | a001-i001-n001 | e001-i001-n001 |
| a001-e001-k001 | a001-e001-o001 | a001-i001-o001 | e001-i001-o001 |
| a001-f001-i001 | a001-f001-m001 | a001-j001-m001 | e001-j001-m001 |
| a001-f001-j001 | a001-f001-n001 | a001-j001-n001 | e001-j001-n001 |
| a001-f001-k001 | a001-f001-o001 | a001-j001-o001 | e001-j001-o001 |

And so on down the line . . .

Step A40. Those model parameters are analyzed by the natural language to eliminate the unreasonable group. For example, the group of parameters basketball jersey—basketball shooting—bat (a001-e001-k001) is judged unreasonable after analysis by the natural language, the group will be deleted from the model parameter list. As an exception, this step can be omitted to have more fun and to increase creativity.

Step A50. An avatar training processor 22 of a model training server 20 extracts the model parameter list from the model database 13, and according to each group of the model parameters, extracts corresponding a plurality of image files from the multimedia database 12. A deep-learning text-to-image diffusion model 70 is used to generate a plurality of avatar models. Those avatar models are respectively related to those model parameters and are saved to the model database 13.

In an embodiment, the avatar training processor 22 makes statistical analysis for those generated avatar models based on the behaviors registered by the users and/or selected by an administrator. The result is then used by the avatar training processor 22 for learning and training.

In an embodiment, those image files include multimedia image files collected from other platforms. After examination and approval by the administrator, they are saved to the multimedia database 12 based on the classifying label.

### Embodiment 4

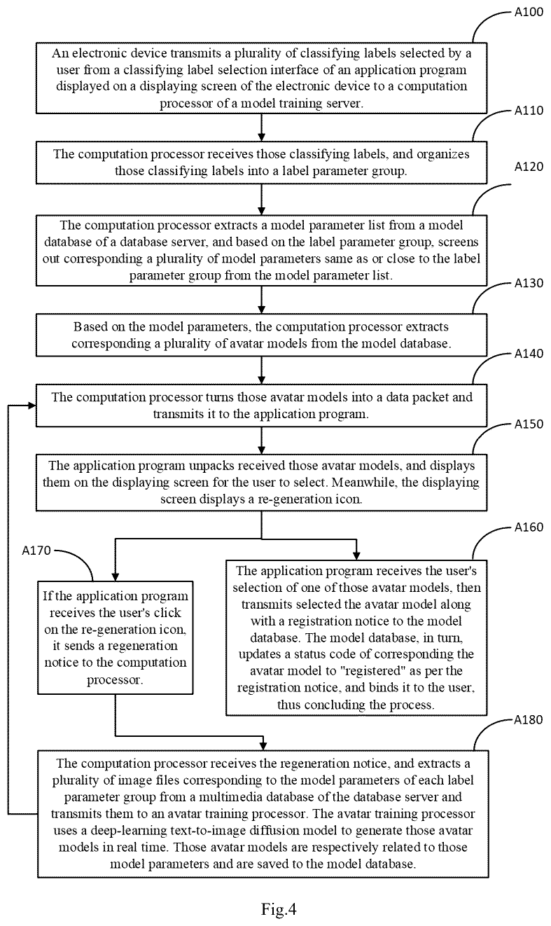

As shown in FIG. 4, the method for a user to produce a user avatar includes: A100. Through an Internet 50, an electronic device 30 transmits a plurality of classifying labels selected by a user from a classifying label selection interface of an application program 31 displayed on a displaying screen 32 of the electronic device 30 to a computation processor 21 of a model training server 20. A110. The computation processor 21 receives those classifying labels, and organizes those classifying labels into a label parameter group. A120. The computation processor 21 extracts a model parameter list from a model database 13 of a database server 10, and based on the label parameter group, screens out corresponding a plurality of model parameters same as or close to the label parameter group from the model parameter list. A130. Based on the model parameters, the computation processor 21 extracts corresponding a plurality of avatar models from the model database 13. A140. The computation processor 21 turns those avatar models into a data packet and transmits it to the application program 31. A150. The application program 31 unpacks received those avatar models, and displays them on the displaying screen 32 for the user to select. Meanwhile, the displaying screen 32 displays a re-generation icon. A160. The application program 31 receives the user's selection of one of those avatar models, then transmits selected the avatar model along with a registration notice to the model database 13. The model database 13, in turn, updates a status code of corresponding the avatar model to “registered” as per the registration notice, and binds it to the user, thus concluding the process. A170. If the application program 31 receives the user's click on the re-generation icon, it sends a regeneration notice to the computation processor 21. A180. The computation processor 21 receives the regeneration notice, and extracts a plurality of image files corresponding to the model parameters of each label parameter group from a multimedia database 12 of the database server 10 and transmits them to an avatar training processor 22. The avatar training processor 22 uses a deep-learning text-to-image diffusion model 70 to generate those avatar models in real time. Those avatar models are respectively related to those model parameters and are saved to the model database 13, repeat A140.

### Embodiment 5

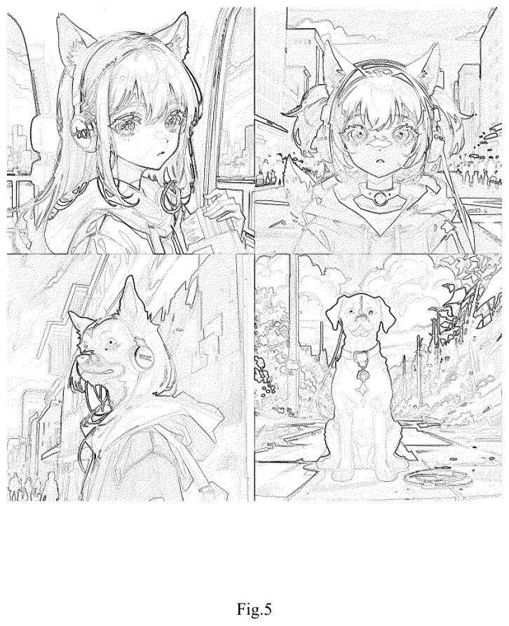

Method for rapidly generating multiple customized user avatars is a method to quickly extract the avatar models from the model database 13 based on those classifying labels selected by the user. The method includes: The user opens the application program 31 on the electronic device 30. The displaying screen 32 displays the classifying label selection interface. Respectively, the user selects-dog on the person label, selects-listen to music on the action label, selects-park on the background label, selects-earphone on the ornament label, and selects-best quality, high-resolution, simple background, and fine detailed eyes on the other label. The application program 31 transmits those classifying labels to the computation processor 21. The computation processor 21 organizes those classifying labels into the label parameter group, and extracts the model parameter list from the model database 13. Based on the label parameter group, the same or similar model parameters corresponding to the label parameter group are screened out from the model parameter list. Then, based on those model parameters, corresponding those avatar models are extracted from the model database 13, as shown in FIG. 5. This method can quickly provide user avatars meeting the user's requirements, and effectively solves the shortcoming of the prior art that takes 5-10 minutes to generate user avatars.

### Embodiment 6

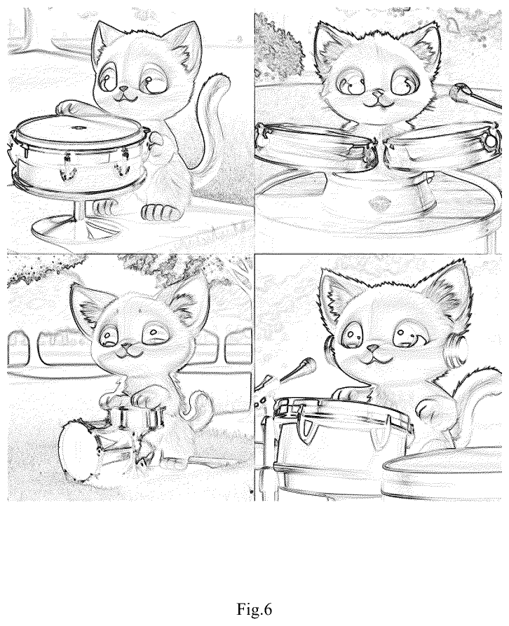

Method for rapidly generating multiple customized user avatars is a method to quickly generate the user avatar based on those classifying labels selected by the user. The method includes: The user opens the application program 31 on the electronic device 30. The displaying screen 32 displays the classifying label selection interface. Respectively, the user selects-cat on the person label, selects-jazz drum on the object label, selects-play on the action label, selects-park on the background label, selects-earphone on the ornament label, and selects-best quality, high-resolution, simple background, fine detailed eyes, and no humans on the other label. The application program 31 transmits those classifying labels to the computation processor 21. The computation processor 21 organizes those classifying labels into the label parameter group, and those model parameters corresponding to the label parameter group are extracted from the multimedia database 12 corresponding to a plurality of image files in each group and sent to the avatar training processor 22, the avatar training processor 22 uses the deep-learning text-to-image diffusion model 70 to instantly generate those avatar models, as shown in the schematic diagram of FIG. 6.

### Embodiment 7

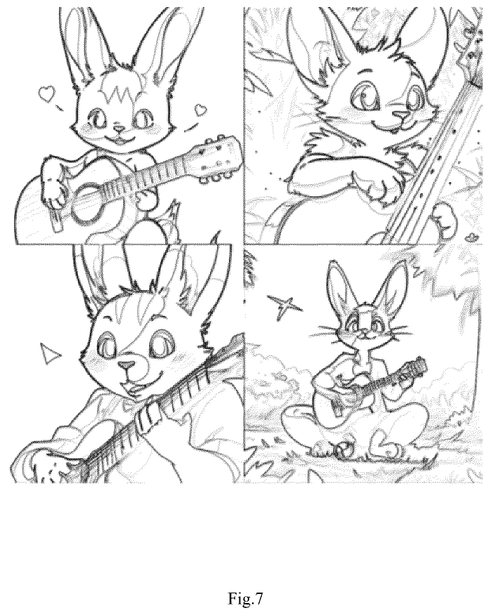

In the classifying label input field of the classifying label selection interface, the user enters -rabbit on the person label, enters -playing guitar on the action label, enters -park on the background label, enters -earphone on the ornament label, and enters -best quality, high-resolution, simple background, fine detailed eyes, and no humans on the other label. The application program 31 transmits those classifying labels to the computation processor 21. The computation processor 21 organizes those classifying labels into the label parameter group, and extracts the model parameter list from the model database 13. Based on the label parameter group, the same or similar model parameters corresponding to the label parameter group are screened out from the model parameter list. Then, based on those model parameters, corresponding those avatar models are extracted from the model database 13, as shown in FIG. 7.

### Embodiment 8

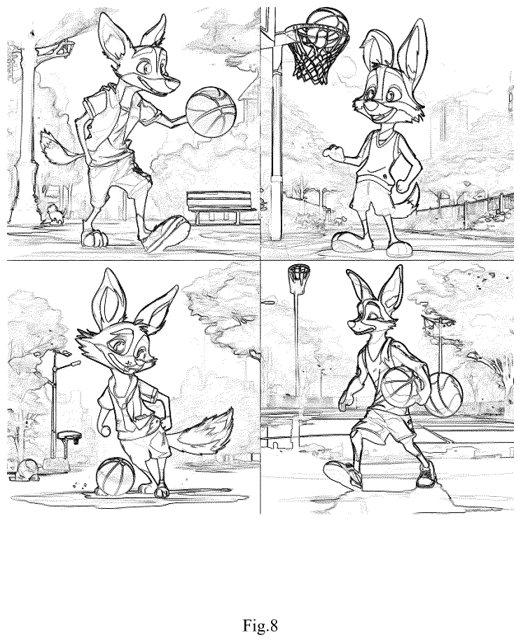

In the classifying label input field of the classifying label selection interface, the user enters a string of texts: -personality of the dog, cartoon style, 2D image, wearing a garment, playing basketball, using park as the background, role of the dog in the city of animals, wash painting, full body shot, and low-resolution image. The application program 31 transmits the text string entered in the classifying label to the avatar training processor 22 of the computation processor 21. The avatar training processor 22 uses the deep-learning text-to-image diffusion model 70 to generate the avatar models in real time, as shown in FIG. 8.

### Embodiment 9

Method for rapidly generating multiple customized user avatars includes: through an Internet 50, an electronic device 30 transmits a plurality of classifying labels selected by a user from a classifying label selection interface of an application program displayed on a displaying screen 32 of the electronic device 30 to a model training server 20, the model training server 20 receiving those classifying labels, organizing those classifying labels into a label parameter group, extracting a model parameter list from a database server 10, further screening out corresponding a plurality of model parameters same as or similar to the label parameter group, then, based on those model parameters, extracting corresponding a plurality of avatar models from the database server 10, packing those avatar models and transmitting them to the application program, the application program receiving those avatar models, unpacking them, and showing them on the displaying screen 32 for the user to select.

In the above method, while the displaying screen 32 shows those avatar models, it also displays a re-generation icon. If the user clicks the re-generation icon, the application program transmits a regeneration notice to the model training server 20. The model training server 20 receives the regeneration notice and uses a deep-learning text-to-image diffusion model 70 to generate those avatar models in real time. After packing, those avatar models are transmitted to the application program, the application program unpacks received those avatar models and shows them on the displaying screen 32 for the user to select.

In an embodiment, the model training server 20 receives the regeneration notice, and extracts corresponding a plurality of image files from the database server 10 based on those model parameters corresponding to each label parameter group. The model training server 20 uses the deep-learning text-to-image diffusion model to generate those avatar models in real time. After packing, those avatar models are transmitted to the application program. The application program receives those avatar models, unpacks them, and shows them on the displaying screen 32 for the user to select. The method to generate those image files includes: the model training server 20 extracting a classifying label list 60 from the database server 10, based on the text contents of those classifying labels, using the deep-learning text-to-image diffusion model 70 to generate those image files, relating those image files to those classifying labels, and saving them to the database server 10.

The mechanisms to change those classifying labels includes: 1. When the number of registration of the avatar model corresponding to the classifying label exceeds the limitation, the avatar training processor will no longer generate avatar models corresponding to the classifying label. 2. With increasing number of registration of the avatar model corresponding to the classifying label, the probability of generation of the avatar model corresponding to the classifying label will be gradually reduced. 3. With increasing number of selection but non-registration of the avatar model corresponding to the classifying label, the avatar training processor will periodically generate the avatar models corresponding to the classifying label.

1. Method for rapidly generating multiple customized user avatars includes: through an Internet, an electronic device transmits a plurality of classifying labels selected by a user from a classifying label selection interface of an application program displayed on a displaying screen of the electronic device to a model training server, the model training server receiving those classifying labels, organizing those classifying labels into a label parameter group, extracting a model parameter list from a database server, further screening out corresponding a plurality of model parameters same as or similar to the label parameter group, then, based on those model parameters, extracting corresponding a plurality of avatar models from the database server, packing those avatar models and transmitting them to the application program, the application program receiving those avatar models, unpacking them, and showing them on the displaying screen for the user to select.

2. The method defined in claim 1, the application program receives the user's selection of one of those avatar models, then transmits selected the avatar model along with a registration notice to the database server, the database server, in turn, updates a status code of corresponding the avatar model to “registered” as per the registration notice, and binds it to the user.

3. The method defined in claim 1, the displaying screen shows those avatar models, it also displays a re-generation icon, if the user clicks the re-generation icon, the application program transmits a regeneration notice to the model training server.

4. The method defined in claim 3, the model training server receives the regeneration notice and uses a deep-learning text-to-image diffusion model to generate those avatar models in real time, after packing, those avatar models are transmitted to the application program, the application program unpacks received those avatar models and shows them on the displaying screen for the user to select.

5. The method defined in claim 3, the model training server receives the regeneration notice, and extracts corresponding a plurality of image files from the database server based on those model parameters corresponding to each label parameter group, the model training server uses the deep-learning text-to-image diffusion model to generate those avatar models in real time, after packing, those avatar models are transmitted to the application program, the application program receives those avatar models, unpacks them, and shows them on the displaying screen for the user to select.

6. The method defined in claim 5, the method to generate those image files includes, the model training server extracting a classifying label list from the database server, based on the text contents of those classifying labels, using the deep-learning text-to-image diffusion model to generate those image files, relating those image files to those classifying labels, and saving them to the database server.

7. The method defined in claim 1, those classifying labels including garment, action, object, person, background, ornament, style, another, and a classifying label input field.

8. The method defined in claim 1, those model parameters are analyzed by a natural language to eliminate the unreasonable group.

9. The method defined in claim 1, the model training server further includes a similarity computing to compute a degree of model similarity between those avatar models in the same group.

10. The method defined in claim 1, those classifying labels are preset by a user behavior of the user, the user behavior collects interaction data on the platform related to the user through the APP.
